(19) United States
(12) Patent Application Publication
(10) Pub. No.: US 2013/0332449 A1
(43) Pub. Date: Dec. 12, 2013

(54) GENERATING DATA PROCESSING CODE FROM A DIRECTED ACYCLIC GRAPH

(71) Applicant: Revitas, Inc., Philadelphia, PA (US)

(72) Inventors: John David Amos, Palo Alto, CA (US); Oleg Merlugov, San Jose, CA (US)

(21) Appl. No.: 13/911,745

(22) Filed: Jun. 6, 2013

Related U.S. Application Data
(60) Provisional application No. 61/656,227, filed on Jun. 6, 2012.

(51) Int. Cl. G06F 17/30

(52) U.S. Cl. CPC G06F 17/30958
USPC 707/714; 707/798; 707/776

(57) ABSTRACT

The present invention provides a computer-implemented code generation system that generates data processing code from a directed acyclic graph (DAG). The generated code is both declarative and procedural, and can be run in a relational database or in a Map Reduce implementation using Apache Pig. Each node of the DAG specifies operations performed on tabular data that can be stored in a delimited plain text file, a spreadsheet, or a relational database.

### BACKGROUND OF THE INVENTION

1. Field of Invention

This invention relates to data management, and in particular, to processing large volumes of data by building graphical models of data transformations.

2. Description of Related Art

There are several options available for data processing. For small data volumes, models can be built and evaluated in a spreadsheet application like Microsoft Excel. Relational databases can store and process larger quantities of data efficiently, especially when there are relationships between data tables. For very high data volumes (e.g., petabytes of data), there are newer tools that process data on multiple computers in parallel.

Each data processing option has its own set of tools and languages available. Many spreadsheets offer built-in formulas and scripting languages. Relational databases use, for example, Structured Query Language (SQL) for declarative processing and many provide support for procedural programming using database-specific languages like Oracle's Procedural Language/Structured Query Language (PL/SQL).

Hadoop is an open-source project administered by the Apache Software Foundation. Hadoop has a Java Application Programming Interface (API) that allows software developers to process large quantities of data, for example, thousands of nodes and petabytes of data, in a computer cluster. Apache Pig makes it easier for individuals to use Hadoop by providing a SQL-like declarative language that can be extended with user-defined functions (UDFs).

One of the common shortcomings of these options is the difficulty of visualizing the flow of data, especially when a procedural language like Java or PL/SQL is used. It is difficult to modify and maintain logic without a clear picture of data flow. The inventors recognized that complex data processing can be expressed in diagrams that are easier to understand and modify than a programming language. For example, a developer can look at a data transformation diagram and quickly see the “big picture” of the complex data processing, and also “drill down” into the details thereof. The inventors discovered that the shortcomings discussed above can be ameliorated by representing the data processing problem as a Directed Acyclic Graph (DAG). In general, a DAG is a directed graph with no directed cycles, and consists of rectangles (nodes) connected by arrows (directed edges). In this context each edge represents a table of data with one or more columns and zero or more rows, and each node represents a data processing operation on the data.

All references cited herein are incorporated herein by reference in their entireties.

### BRIEF SUMMARY OF THE INVENTION

In the context of the present invention, a table is defined as a collection of data values that has one or more columns and zero or more rows. If a table has zero rows then the table is empty. Each column has a name and data type (e.g., character, number, or date). The table could be stored, for example, in a delimited plain text file, a spreadsheet, or a relational database.

Individuals can build a data processing model using a Directed Acyclic Graph (DAG) that shows the flow of data from input tables to output tables. Each node has attributes that specify a number of input tables, a number of output tables, and the operations performed on the data. The present invention generates code (e.g., declarative, procedural) from the DAG that can be evaluated by a third-party data processing tool like Apache Pig or a relational database.

In an example embodiment of the present invention, an open-source data-mining tool called KNIME is used to build a DAG. KNIME saves the DAG in XML files. In the exemplary code generating system, these XML files are transformed using, for example, XSLT, XPath, and DOM, into a single XML file (DAG-XML) that contains all information required to process the data. The resulting DAG-XML file is used to generate Pig Latin and User Defined Functions (UDF) Java Archive (JAR) files for Apache Pig, or SQL scripts for a relational database. The resulting scripts are then run in Apache Pig or a relational database to process the data and produce the results.

The exemplary embodiments include a computer-implemented code generation system that generates data processing code from a directed acyclic graph (DAG). The system includes one or more processors configured to execute computer program modules. The computer program modules include a module to generate code from an XML representation of a DAG having nodes connected by directed edges. The DAG describes a data processing job with all inputs in data tables, all outputs in data tables, only data tables being passed between the nodes in the DAG, and input and output tables being specified for each node in the DAG. The DAG specifies data manipulations to be performed by each node.

The exemplary embodiments also include a computer-implemented code generation system that generates data processing code from a directed acyclic graph (DAG). The system includes a data-mining tool, a compiler, a computer arrangement code generator and a processor. The data-mining tool is adapted to create a DAG that exposes a complete specification of the DAG, with each DAG having nodes connected by directed edges, wherein only data tables are passed between the nodes in the DAG, and input and output tables are specified for each node in the DAG. The compiler is in communication with the data-mining tool, with the compiler compiling the DAG into an XML representation of the DAG. The computer arrangement code generator is in communication with the compiler, with the code generator generating data processing code including an executable file and a supporting script based on the XML representation of the DAG. The processor is in communication with the code generator, with the processor executing the data processing code in accordance with the executable file and the supporting script.

In an example of the embodiments, the data processing code includes a first executable file segment built by the code generator based on the DAG-XML file including a representation of all of the DAG directed edges with all data processing models starting with a load node, a second executable file segment built by the code generator for each load node based on the DAG-XML file and identifying each load node as resolved, and a third executable file segment built by the code generator including a list of unresolved nodes based on the DAG-XML file. In this example, the code generator recursively traverses the DAG directed edges locating nodes between the directed edges with unresolved parent nodes, builds further executable file segments for the unresolved parent nodes, and identifies the unresolved nodes as resolved. The code generator continues the recursively traversing step until all nodes are identified as resolved, with the executable file including the built first, second, third and further executable file segments.

The exemplary embodiments further include a method for generating data processing code from a directed acyclic graph (DAG). The method includes the steps of creating a DAG with a data-mining tool that provides a complete specification of the DAG, each DAG having nodes connected by directed edges, wherein only data tables are passed between the nodes in the DAG, and input and output tables are specified for each node in the DAG, compiling the DAG into an XML representation of the DAG via a compiler in communication with the data-mining tool, the XML representation of the DAG being a DAG-XML file, generating data processing code with a computer arrangement code generator, the generated data processing code including an executable file and a supporting script based on the DAG-XML file, and executing the data processing code with a processor in accordance with the executable file and the supporting script. In an example of this method, the generating step includes building a first executable file segment based on the DAG-XML file including a representation of all of the DAG directed edges with all data processing models starting with a load node, building a second executable file segment for each load node based on the DAG-XML file and identifying each load node as resolved, building a third executable file segment including a list of unresolved nodes based on the DAG-XML file, recursively traversing the DAG directed edges locating nodes between the directed edges with unresolved parent nodes, building further executable file segments for the unresolved parent nodes and identifying the unresolved nodes as resolved, and continuing the recursively traversing step until all nodes are identified as resolved, with the executable file including the built first, second, third and further executable file segments.

### BRIEF DESCRIPTION OF SEVERAL VIEWS OF THE DRAWINGS

The invention will be described in conjunction with the following drawings in which like reference numerals designate like elements and wherein:

FIG. 1 is a block diagram of an exemplary data processing environment that is used to implement the code generating system of an exemplary embodiment of the invention;

FIG. 2 is a diagram showing a flowchart of a code generation process that might be used with an embodiment of the present invention;

FIG. 3 is a diagram showing an exemplary Directed Acyclic Graph (DAG);

FIG. 4 depicts a table of exemplary syntax used for the node types discussed for the exemplary embodiments; and

FIG. 5 depicts a diagram showing a flowchart of the steps used by the code generator to create code from the DAG.

### DETAILED DESCRIPTION OF THE INVENTION

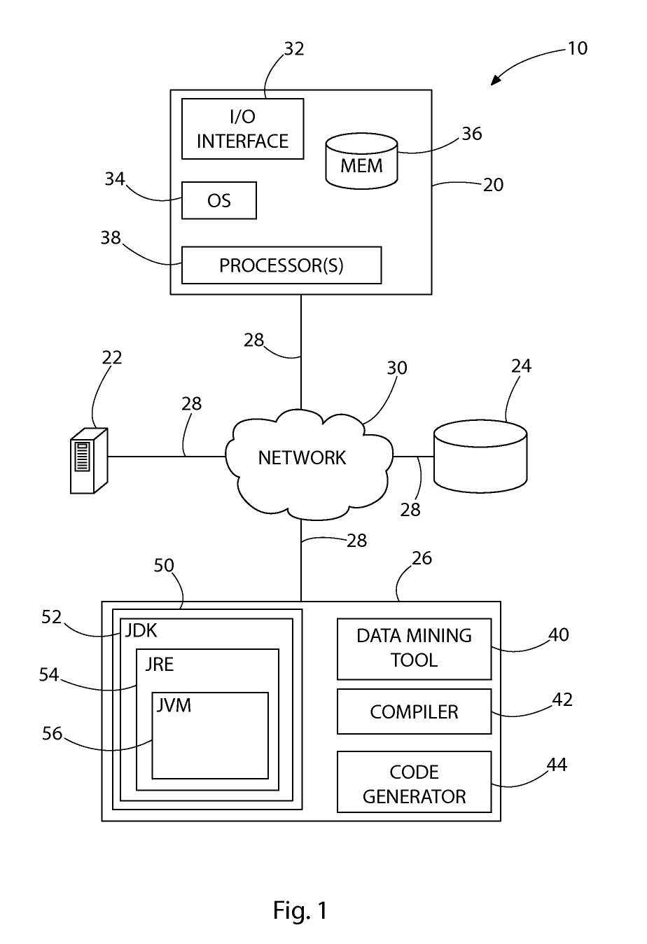

Referring now in greater detail to the various figures of the application, wherein like-referenced characters refer to like parts, a general communication environment including an exemplary code generating system 10 of the invention is illustrated in FIG. 1. With reference to FIG. 1, a block diagram is provided illustrating the exemplary code generating system 10 in which embodiments of the present invention may be employed. It should be understood that this and other arrangements described herein are provided only as examples. Other examples, and elements (e.g., communications, components, devices, features, functions, interfaces, machines, structure, apparatus and arrangements thereof) can be used in addition to or in alternative to those shown and discussed, and some arrangements and elements may be omitted as would be understood by a skilled artisan. Moreover, many of the elements described herein are functional entities that may be implemented as discrete or distributed elements or in combination with other elements, and in any suitable location as understood by a skilled artisan. It should also be understood that various functions described or inferred herein as being performed by one or more entities may be executed by any combination of hardware, software and firmware. For example, such various functions may be performed by a processor executing instructions (e.g., program code) stored in memory.

FIG. 1 depicts an exemplary code generating system 10 that may include a client computer 20, a server 22, data storage medium 24, a computing arrangement 26, and communication connections 28 there between. Each of the devices shown in FIG. 1 may be any type of computing apparatus, such as the computer 20 described in greater detail below. The devices may communicate with each other via a network 30, which may include, without limitation, one or more local area networks and or wide area networks. The network 30 may be a packet-switched network, preferably an IP based network, i.e., a communication network having a common layer three IP layer, such as the Internet. The network 30 may also include a telecommunication system comprising circuit-switched telephony networks and packet-switched telephony networks. The client computer 20 may include one or more mobile communication terminals, e.g., cellular phones, capable to send/receive and process data. The circuit-switched networks may be, e.g., Public Switched Telephone Networks (PSTN), Integrated Services Digital Networks (ISDN), Global System for Mobile Communication (GSM), or Universal Mobile Telecommunication Services (UMTS) networks.

The client computer 20 may provide a vehicle for communicating, creating, building, compiling, displaying and executing elements of the invention. Further, the client 20 may vacilitate the communication of information between a user of the client and one or more components of the code generating system 10. The code generating system 10 is but one example of a suitable computing environment and is not intended to suggest any limitation as to the scope of use or functionality of the invention. Neither should the code generating system 10 be interpreted as having any dependency or requirement relating to any one or combination of modules/components illustrated.

The client computer 20 may include an I/O interface 32, an operating system 34, memory 36 and a processor(s) 38 directly or indirectly coupled therebetween via a bus (not shown but including, for example, an address bus, a data bus, a combination thereof). The I/O interface 32 may include inputs, outputs, communication modules, and display modules for communication within the client 20 and external with other components of the code generating system 10. Exemplary I/O interface members include but are not limited to one or more keyboards, mouses, display devices, microphones, speakers, printers, modems, joysticks, controllers, remotes, wireless devices, transceivers, etc.

The operating system 34 may include a set of programs that manage the computer hardware resources and provides common services for application software. The memory 36 may include database and computer storage media in the form of volatile and/or nonvolatile memory that may be removable. Exemplary memory includes and is not limited to hard drives, solid-state memory, optical drives, etc. The processor 38 includes one or more processors that read, process and execute data and instructions from various sources from the client computer 20 or other entities (e.g., servers 22, data storage medium 24, network 30).

Still referring to FIG. 1, the server 22 may include a client computer 20 as the server. Like the client computer 20, the server 22 may include an I/O interface 32, an operating system 34, memory 36 and a processor(s) 38 directly or indirectly coupled via a bus. Further, the server 22 (and the client 20) may be implemented as one or more servers with a peer-to-peer and/or hierarchical architecture.

The functionalities of the code generating system 10 provided by the client 20 and server(s) 22, with or without connection with the data storage medium 24, may be realized as separate, independent units or in a de-centralized structure where the functionalities are provided by a plurality of interdependent de-centralized components and devices. For example, while the client 20 and the server 22 represent distinct computing devices used in implementing examples of the invention, it is understood that numerous computing devices may be implemented to perform examples of the invention. The data storage medium 24 is located within one or more computing devices of the client 20 and/or the server 22, and/or is assessable as a single unit or a plurality of distributed units via the network 30.

The computing arrangement 26 is a computing cluster for implementing aspects of the invention. As such, the client computer 20 and server(s) 22 may be incorporated in the computing arrangement 26. In other words, the computing arrangement 26 may include components included as a whole or in part in the client computer 20, in one or more of the servers 22, in a stand-alone independent computing device (e.g., data storage medium) accessible via the network 30, or any combination thereof. Accordingly, reference to the computing arrangement 26 includes yet is not limited to a reference to the client computer 20 and the server(s) 22.

While not being limited to a particular theory, the computing arrangement 26 includes tools, platforms and an environment for developing and deploying the code generating system of the invention. In an exemplary embodiment, the computing arrangement 26 includes a data mining tool 40, a compiler 42, a code generator 44 and a platform environment (e.g., Java) 50. In this example, the platform environment is a Java platform that includes a Java Runtime Environment (JRE) 52, a Java Development Kit (JDK) 54, and a Java Virtual Machine (JVM) 56. The Java Runtime Environment (JRE) 52 provides the libraries, the JVM 56, and other components to run applets and applications written in the Java programming language. The Java Development Kit 54 includes the JRE 52, a Java compiler, a Java interpreter, developer tools, Java API libraries, and documentation that can be used by Java developers to develop Java-based applications. The Java compiler may include the compiler 42 and converts java code into byte code. The JVM 56 converts the byte code into user understandable output.

The example embodiment of the present invention discussed below is preferably written in the Java language and requires the Java Virtual Machine 56 to run. In addition, compilation of generated class files for User Defined Functions (UDFs) requires the JDK 54 because the JVM runtime does not include a Java compiler. Any hardware that supports a JDK can be used to run the example embodiment.

Any software application could be used to create the Directed Acyclic Graph (DAG) provided that it allows the user to specify the data processing parameters for each node and exposes the DAG to external applications. In this example embodiment, an open-source data-mining tool 40 (e.g., KNIME) is used to build a DAG. The data-mining tool saves the DAG in XML files.

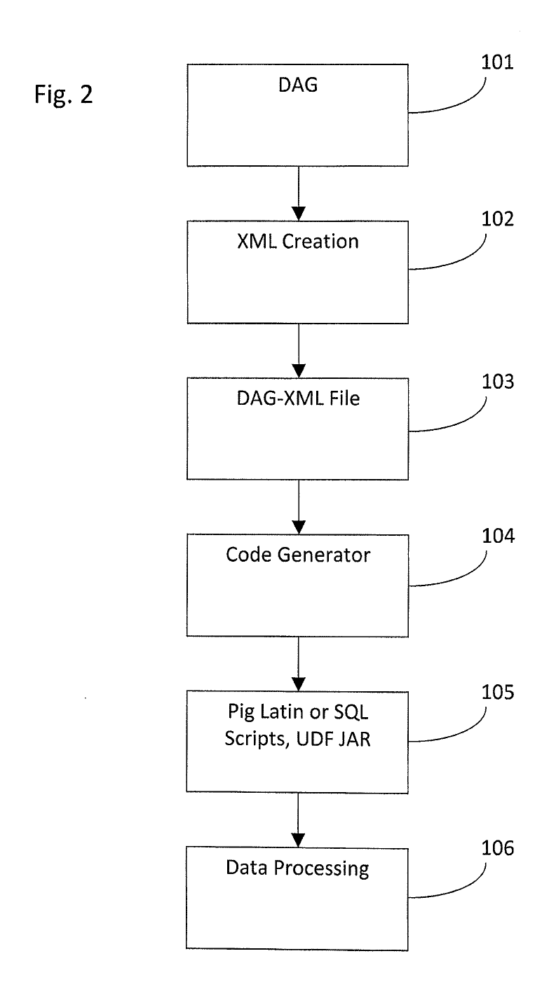

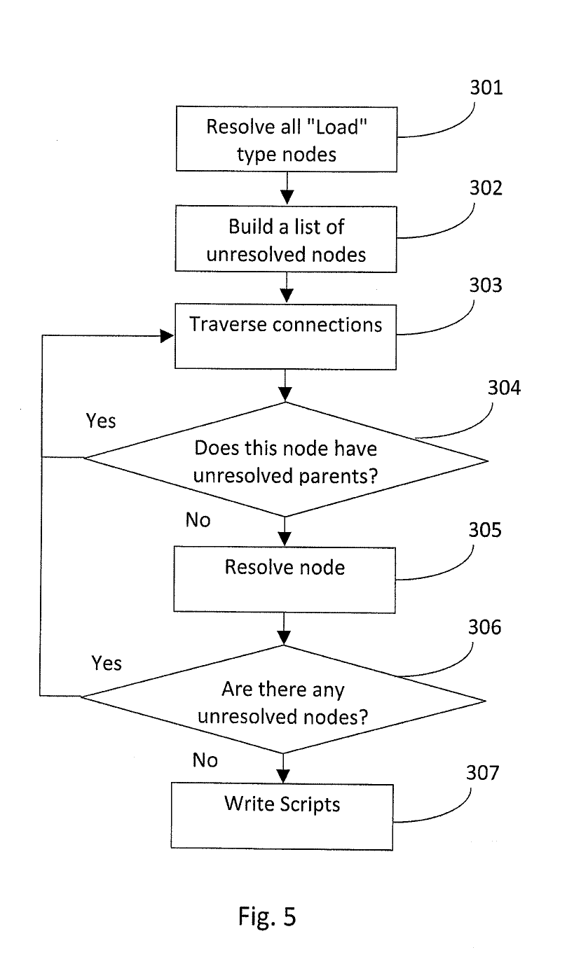

FIG. 2 depicts a flowchart illustrating the code generation process as seen by a user of one embodiment of the present invention. At step 101 of the process, a software tool (e.g., data-mining tool 40) creates a DAG that exposes a complete specification of the DAG for use in the present invention. At step 102, the compiler 42 compiles the DAG into an XML representation of the DAG, which is identified at step 103 as a created DAG-XML file. Based on the DAG-XML file, the code generator 44 runs a code generation procedure (FIG. 5) to generate data processing code at step 104, preferably as at least one executable file, including but not limited to any one or more of Pig Latin, SQL, UDF JAR files, and any other supporting scripts, at step 105. Further details of this step 105 will be discussed below with reference to FIG. 5. Then at step 106, the processors 38 deploy and run the executable file(s) and scripts in the data processing environment of the code generating system 10 established at least in part by the client computer 20, the server(s) 22, the data storage medium 24, and the network 30.

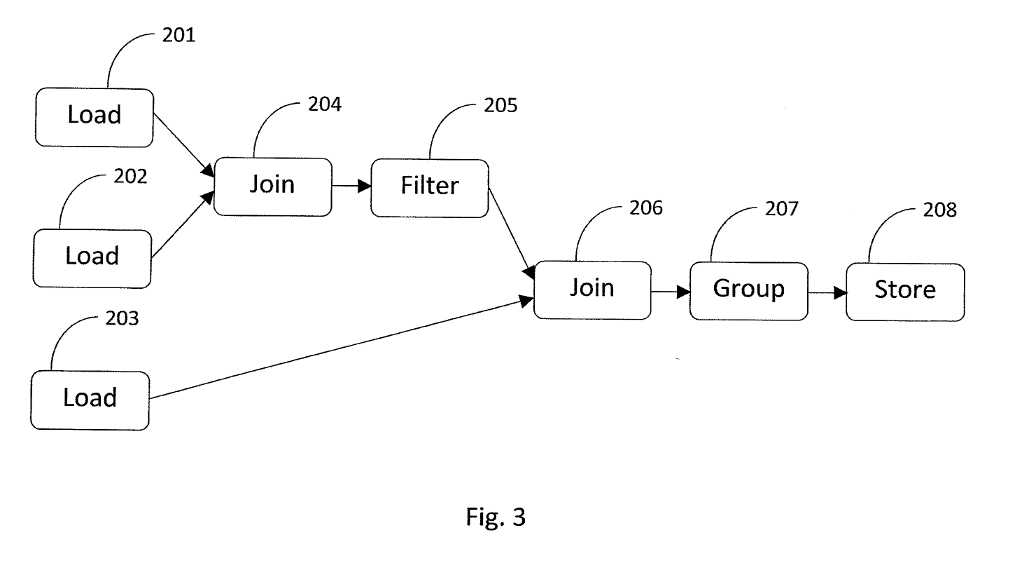

FIG. 3 depicts an exemplary DAG of the invention. Each directed edge (connection) in the DAG has a source node and destination node. In addition some nodes may have more than one input and/or output table, so each directed edge also has a qualifying integer (a port) that completes the specification of the connection between two nodes. The set of connections is stored in the DAG and in the DAG-XML file used by the code generator 44. Of course, this example is merely illustrative and not intended to be fully representative of a real data processing model. In this example, the data mining tool 40 loads three different tables 201, 202, and 203 using a “Load” type node. Tables produced by nodes 201 and 202 are joined on one or more columns in node 204 and the resulting table is filtered in node 205. The table produced by node 205 is joined in node 206 with the table loaded in node 203 and then the resulting table is grouped by one or more columns in node 207. The table produced by node 207 is stored in node 208.

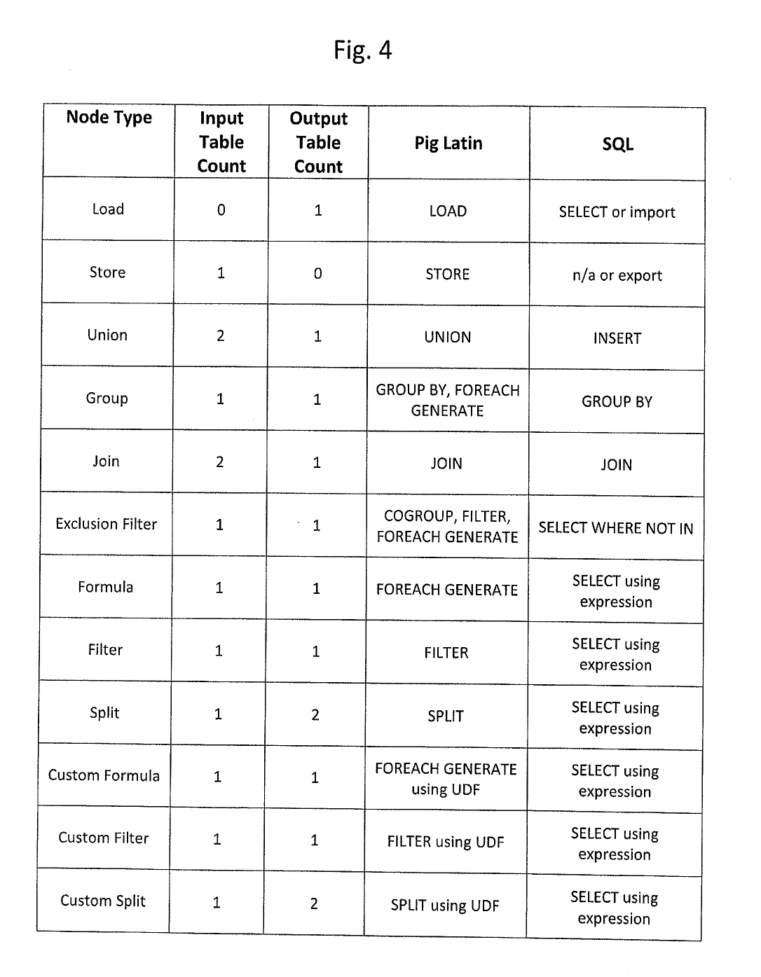

The exemplary embodiments of the present invention support at least twelve different node types, although support for additional node types could be added as needed. With these twelve node types it is possible to model many different data processing scenarios provided that all input and output data is in tables. Additional information about each node type can be found in FIG. 4 of the drawings.
1. Load—represents loading an input table from storage. This node has no input tables and one output table.
2. Store—represents writing an output table to storage. This node has one input table and no output tables.
3. Union—merges two tables into one by adding all rows from each table into the result. This node has two input tables and one output table.
4. Group—groups rows within a table by the values of specified columns. This node has one input table and one output table.
5. Join—merges two tables into one by performing a SQL-like join on one or more columns. This node has two input tables and one output table.
6. Exclusion Filter—filters rows from one table if the value in one column exists in a specified column of another table. This node has two input tables and one output table.
7. Formula—creates or replaces a column in a table using a formula that is supported by Pig Latin and SQL. This node has one input table and one output table.
8. Filter—filters rows from a table using a formula that is supported by Pig Latin and SQL. This node has one input table and one output table.
9. Split—splits one table into two using a formula that is supported by Pig Latin and SQL. This node has one input table and two output tables.
10. Custom Formula—creates or replaces a column in a table using custom Java or SQL code. This node has one input table and one output table.
11. Custom Filter—filters rows using custom Java or SQL code. This node has one input table and one output table.
12. Custom Split—splits one table into two using custom Java or SQL code. This node has one input table and two output tables.

FIG. 4 also depicts the syntax used to assemble the expressions for each of the twelve node types supported by the example embodiments of the invention. Expressions for each node type may be assembled by concatenating character strings using the syntax of the data processing engine and the configuration parameters for the node. When generating Pig Latin, the Custom Formula, Custom Filter, and Custom Splitter node types require a Java source file to be created to contain the custom Java code. The code generator creates the Java source file, compiles it, and adds the resulting Java class file to a JAR file. The JAR file contains all UDFs required for the data processing job. A declaration is added to the Pig Latin script so that the UDF can be called within the script.

FIG. 5 depicts an internal code generation process used by the code generator 44 discussed above. The code generator 44 reads the DAG-XML and builds an in-memory representation of all connections. For example, all data processing models must start with at least one “Load” node because otherwise there is no data to process, so the code generation process starts there. The code generator 44 finds all “Load” nodes and then builds code for each “Load” node based on the specifications in the DAG-XML file at step 301. Each “Load” node is accordingly marked as “resolved” in memory. Next a list of unresolved nodes is built at step 302. Nodes resolved during the code generation process are removed from this list. The generator recursively traverses the connections at steps 303 and 304, generating code and resolving the node at step 305 when all ancestors of that node have been resolved. A loop condition at step 306 is used to continue this process until all nodes have been resolved. The scripts are written at step 307, resulting in a syntactically correct Pig Latin or SQL script that never tries to use a data table before it has been defined.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

It is understood that the code generating system and methods thereof described and shown are exemplary indications of preferred embodiments of the invention, and are given by way of illustration only. In other words, the concept of the present invention may be readily applied to a variety of preferred embodiments, including those disclosed herein. It will be understood that certain features and sub combinations are of utility, may be employed without reference to other features and sub combinations, and are contemplated within the scope of the claims. Not all steps listed in the various figures need be carried out in the specific order described.

While the invention has been described in detail and with reference to specific examples thereof, it will be apparent to one skilled in the art that various changes and modifications can be made therein without departing from the spirit and scope thereof. Without further elaboration, the foregoing will so fully illustrate the invention that others may, by applying current or future knowledge; readily adapt the same for use under various conditions of service.

What is claimed is:

1. A computer-implemented code generation system that generates data processing code from a directed acyclic graph (DAG), the system comprising:
one or more processors configured to execute computer program modules, the computer program modules including a module to generate code from an XML representation of a DAG having nodes connected by directed edges, the DAG describing a data processing job with all inputs in data tables, all outputs in data tables, only data tables being passed between the nodes in the DAG, and input and output tables being specified for each node in the DAG, the DAG specifying data manipulations to be performed by each node.

2. The system of claim 1, wherein the generated code includes declarative code and procedural code.

3. The system of claim 1, wherein the nodes in the DAG support multiple operations, including joining, grouping, and filtering tabular data.

4. The system of claim 3, wherein the code generated from the XML representation of the DAG includes one of SQL statements and Pig Latin statements generated based on the joining data.

5. The system of claim 1, wherein the generated code is executed in one of a relational database and a map reduce cluster.

6. The system of claim 1, wherein the processor executes computer program modules having an executable file and scripts from a client computer.

7. A computer-implemented code generation system that generates data processing code from a directed acyclic graph (DAG), the system comprising:
a data-mining tool adapted to create a DAG that exposes a complete specification of the DAG, each DAG having nodes connected by directed edges, wherein only data tables are passed between the nodes in the DAG, and input and output tables are specified for each node in the DAG;
a compiler in communication with said data-mining tool, said compiler compiling the DAG into an XML representation of the DAG;
a computer arrangement code generator in communication with said compiler, said code generator generating data processing code including an executable file and a supporting script based on the XML representation of the DAG; and
a processor in communication with said code generator, said processor executing the data processing code in accordance with the executable file and the supporting script.

8. The system of claim 7, the data processing code including a first executable file segment built by said code generator based on the DAG-XML file including a representation of all of the DAG directed edges with all data processing models starting with a load node, a second executable file segment built by said code generator for each load node based on the DAG-XML file and identifying each load node as resolved, and a third executable file segment built by said code generator including a list of unresolved nodes based on the DAG-XML file,
said code generator recursively traversing the DAG directed edges locating nodes between the directed edges with unresolved parent nodes, building further executable file segments for the unresolved parent nodes, and identifying the unresolved nodes as resolved, said code generator continuing the recursively traversing step until all nodes are identified as resolved, the executable file including the built first, second, third and further executable file segments.

9. The system of claim 7, the code generator generating the supporting script based on the DAG-XML file absent instructions that use undefined data tables.

10. The system of claim 7, said code generator generating data processing code including SQL statements based on joining, grouping, and filtering tabular data.

11. The system of claim 7, the generated data processing code including declarative code.

12. The system of claim 7, the nodes in the DAG supporting joining, grouping, and filtering tabular data operations.

13. The system of claim 7, wherein the processor executes the generated processing code in one of a relational database and a map reduce cluster.

14. A method for generating data processing code from a directed acyclic graph (DAG), comprising:
creating a DAG with a data-mining tool that provides a complete specification of the DAG, each DAG having nodes connected by directed edges, wherein only data tables are passed between the nodes in the DAG, and input and output tables are specified for each node in the DAG;
compiling the DAG into an XML representation of the DAG via a compiler in communication with the data-mining tool, the XML representation of the DAG being a DAG-XML file;
generating data processing code with a computer arrangement code generator, the generated data processing code including an executable file and a supporting script based on the DAG-XML file; and
executing the data processing code with a processor in accordance with the executable file and the supporting script.

15. The method of claim 14, the generating step including:
building a first executable file segment based on the DAG-XML file including a representation of all of the DAG directed edges with all data processing models starting with a load node,
building a second executable file segment for each load node based on the DAG-XML file and identifying each load node as resolved,
building a third executable file segment including a list of unresolved nodes based on the DAG-XML file,
recursively traversing the DAG directed edges locating nodes between the directed edges with unresolved parent nodes, building further executable file segments for the unresolved parent nodes and identifying the unresolved nodes as resolved, and
continuing the recursively traversing step until all nodes are identified as resolved, the executable file including the built first, second, third and further executable file segments.

16. The method of claim 15, wherein each node is resolved when all ancesters of the node are identified as resolved.

17. The method of claim 14, the generating step including generating the supporting script based on the DAG-XML file absent instructions that use undefined data tables.

18. The method of claim 14, the generating step including generating the data processing code with SQL statements.

19. The method of claim 14, the generated data processing code including declarative code.

20. The method of claim 14, wherein the generated data processing code is generated in one of a relational database and a map reduce cluster.
